(19) United States
(12) Patent Application Publication
(10) Pub. No.: US 2006/0032276 A1
(43) Pub. Date: Feb. 16, 2006

(54) Lock assembly

(75) Inventors: Mark Early, Kneeland, CA (US); Joseph J. Settelmayer, Fieldbrook, CA (US)

Correspondence Address: KOLISCH HARTWELL, P.C., 200 PACIFIC BUILDING, 520 SW YAMHILL STREET, PORTLAND, OR, 97204, US

(73) Assignee: Yakima Products, Inc.

(21) Appl. No.: 11/197,761

(22) Filed: Aug. 3, 2005

Related U.S. Application Data
(60) Provisional application No. 60/601,682, filed on Aug. 12, 2004.

(51) Int. Cl. E05B 73/00

(52) U.S. Cl. 70/58

(57) ABSTRACT

A security device for locking a paddle or other item having a shaft to a vehicle includes a cuff that can be locked in a closed position using a cable and lock housing.

### CROSS REFERENCE TO RELATED APPLICATION

This application is based upon and claims priority under 35 U.S.C. §119 from U.S. Provisional Patent Application Ser. No. 60/601,682 filed Aug. 12, 2004 which is incorporated herein by reference in its entirety for all purposes.

### BACKGROUND

Top-mounted vehicle racks provide a versatile platform for transporting bicycles, skis, snowboards, boats, cargo boxes, gear racks, and other items. However, racks configured to carry boats such as kayaks may not be equipped to carry or properly secure a kayak paddle or other awkward or bulky accessory items. For example, some vehicle owners who transport kayaks or other types of boats must transport the accompanying paddle(s) inside the vehicle. Some vehicle racks accept mounting mechanisms designed to carry a paddle, but these mechanisms typically are not designed to secure the paddle to the rack in a manner that effectively deters or prevents theft.

Vehicle roof racks typically include a pair of crossbars that extend side-to-side across the top of a vehicle. Each crossbar is supported on each side of the vehicle's roof by a tower, and the distance between crossbars may depend on factors such as the shape and size of the vehicle's roof. A mounting mechanism for carrying a paddle may include brackets that attach to each crossbar, and straps for securing the paddle to each bracket, or a similar mechanism. To remove the paddle, the straps typically may be manually loosened and partially detached from their respective brackets.

When a vehicle is left unattended, it is sometimes desirable to lock the paddle to the rack, to prevent or at least to substantially deter theft of the paddle. Thus, a need exists for a mechanism to securely attach or lock a paddle or other accessory item to a vehicle rack in a manner that deters or prevents theft.

### SUMMARY

A security device for locking a paddle or other item having a shaft to a vehicle includes a cuff that can be locked in a closed position using a cable and lock housing.

### BRIEF DESCRIPTION OF THE FIGURES

FIG. 1 is a perspective view of a rack, paddle and a paddle locking assembly.

FIG. 2 is a perspective view of the paddle locking assembly shown in FIG. 1.

FIG. 3 is a perspective view of the cuff shown in FIGS. 1 and 2, in an open position.

FIG. 4 is a perspective view of an alternative cuff embodiment in an open position.

FIG. 5 is an end view of the cuff shown in FIG. 4 with the closed position shown in solid lines, and the open position shown in dashed lines.

FIG. 6 is an end view of an alternative cuff embodiment configured to secure two shafts.

FIG. 7 is an end view of another cuff embodiment.

### DETAILED DESCRIPTION

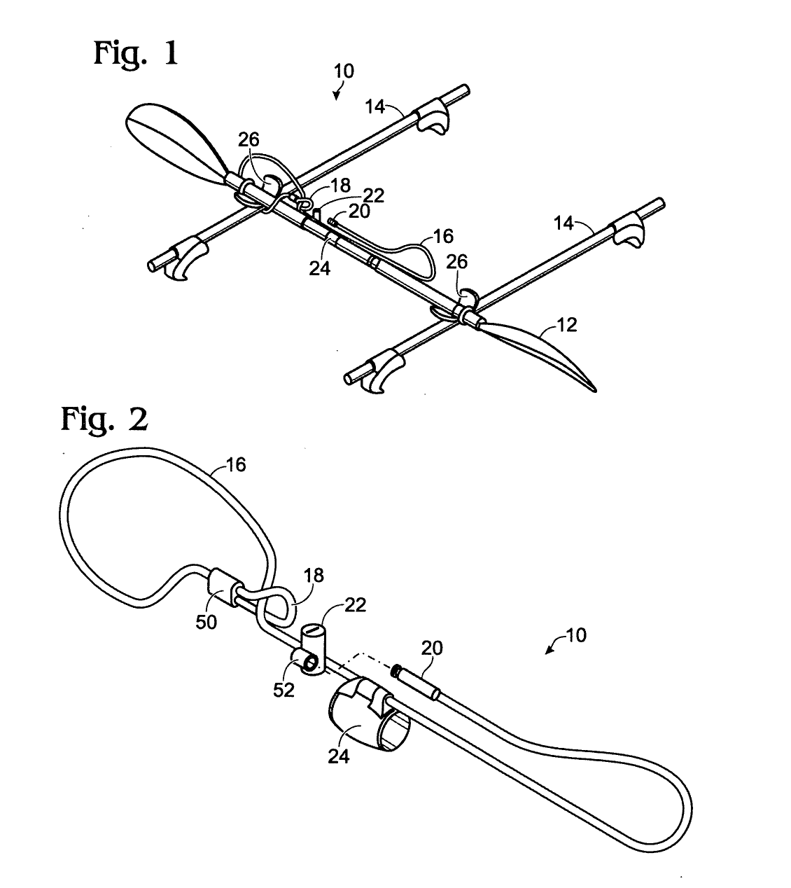

FIG. 1 shows an example of a boat paddle lock assembly 10 for securing paddle 12 to crossbars 14 on top of a vehicle (not shown). FIG. 2 shows an enlarged view of lock assembly 10. Cable 16 has a loop 18 on one end so that cable 16 can pass through a closed loop on the car or rack and then pass through loop 18 before securing other end 20 to lock housing 22, thereby preventing lock assembly 10 from being detached from the vehicle. Cable 16 threads through holes in cuff 24 for grasping the shaft of paddle 12. Paddle lock assembly 10 secures paddle 12 to the roof rack and vehicle to prevent theft. Paddle holder 26 holds paddle 12 in place while the vehicle is moving. Cable 16 may be passed around crossbar 14, through loop 18, and through paddle cuff 24, preventing cuff 24 from opening and thus securing paddle 12 to crossbar 14. Free end 20 of cable 16 may be locked to lock housing 22 by inserting free end 20 into lock housing 22 and exerting a slight pressure until cable end 20 is locked into engagement with lock housing 22. Alternatively, free end 20 may be retained in housing 22 by manipulating a keyed lock device.

While a paddle shaft is used in these examples, any object that has a tubular section able to fit into cuff 24 could be secured by this invention. Examples of other items that could be secured by similar cuff designs include oars, bicycle frames, raft frames or bicycle wheels.

Cable 16 may be long enough to wrap around both crossbars 14 to provide extra security for paddle 12. Cable 16 also may be long enough to secure a canoe or kayak (not shown), for example by passing through a closed loop structure on the kayak. In this manner, a single locking mechanism can be used to secure both a boat and a paddle and/or other accessories carried on the rack.

As shown in FIG. 2, crimp sleeve 50 may be provided to form loop 18, although loop 18 may be formed in numerous other ways. Lock housing 22 may slide on cable 16 while remaining securely attached to cable 16. Lock housing 22 accepts free end 20 which may have a crimped metal sleeve for engaging lock housing 22. Lock housing 22 has tubular portion 52. Cable free end 20 may slide into tubular portion 52 to secure cuff 24 in the closed position.

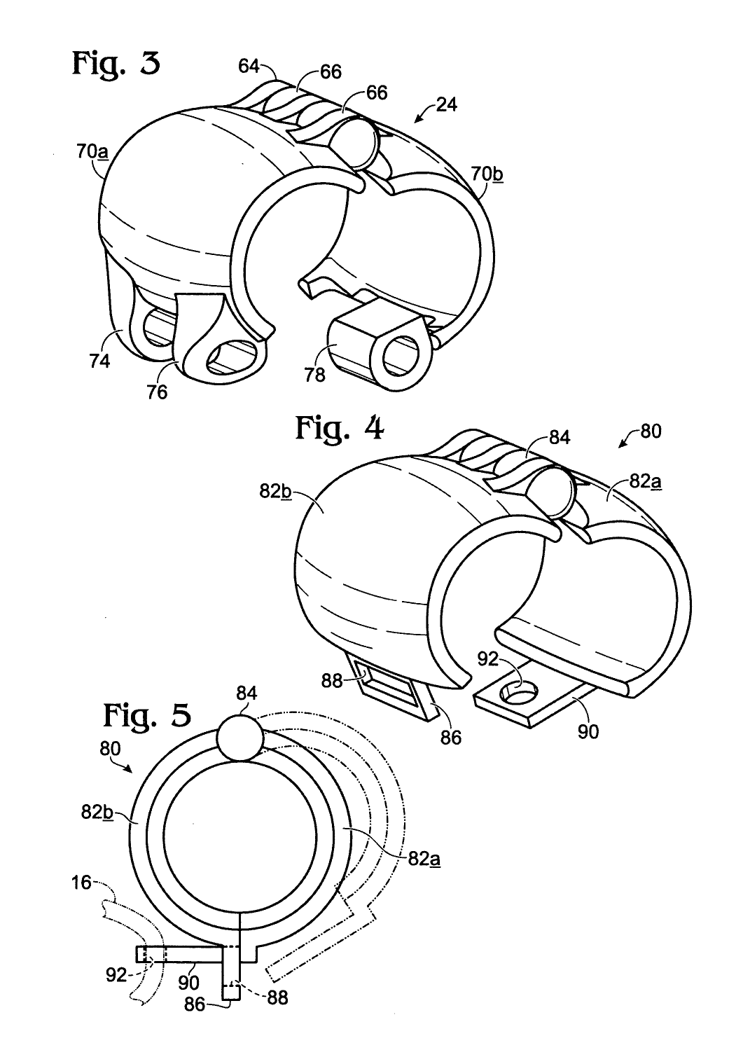

FIG. 3 shows a close-up view of cuff 24 in an open position. Hinge 64 of cuff 24 may be provided to allow cuff 24 to rotate between open and closed positions. The open position of cuff 24 allows insertion and removal of a paddle shaft. The closed position prevents insertion and removal of the shaft from cuff 24. While hinge 64 is shown in FIG. 3 as a pin through looped portions 66 of curved portions 70a and 70b, other hinge-like configurations such as a thinned portion of material continuous between the two sections or any mechanism allowing selective movement of cuff 24 between the open and closed positions may be used.

Tubular portions 74, 76 and 78 of cuff 24 interweave to a collinear position when cuff 24 is closed to form a single passage configured to receive cable 16, thus preventing cuff 24 from opening. Cuff 24 is locked in the closed position when cable 16 passes through the passage. A paddle shaft therefore may be secured within paddle cuff 24 by inserting the paddle shaft into cuff 60 in its open position, rotating curved portions 70a and 70b to the closed position, and threading cable 16 through the passage. Free end 20 of cable 16 may then be secured into lock housing 22. This effectively prevents removal of the paddle shaft from cuff 24 until lock housing 22 is unlocked (typically with a key or combination). Cable 16 may then be removed both from lock housing 22 and from tubular portions 74, 76 and 78. Removal of free end 20 from tubular portions 74, 76 and 78 allows paddle cuff 24 to be rotated or otherwise moved to the open position, so that the paddle shaft may be removed from cuff 24.

FIG. 4 shows an alternative cuff configuration. Cuff 80 is similarly defined, as above, by two curved portions 82a and 82b joined by hinge 84. Cuff 80 has opened and closed positions for securing a paddle shaft. A securing mechanism for cuff 80 includes extension portion 86 with an aperture 88. Aperture 88 is dimensioned to receive extension portion 90. Extension portion 90 has an aperture 92 dimensioned for receiving a cable in the closed position and thereby preventing cuff 80 from opening. FIG. 5 shows an end view of cuff 80. Curved portion 82a is shown in solid lines closed, and in dashed lines open.

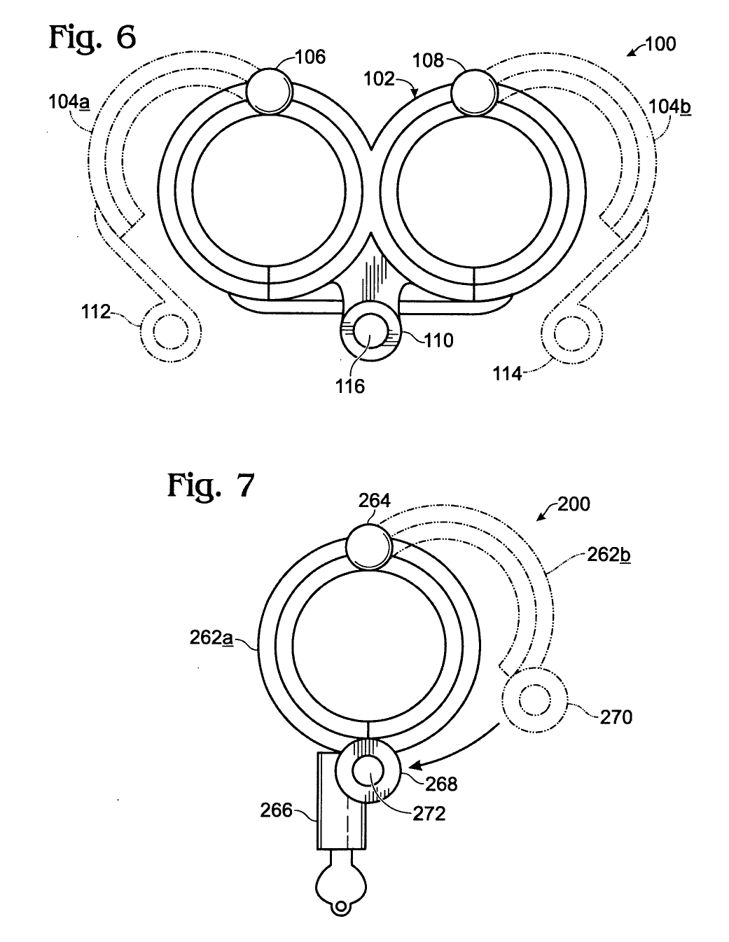

FIG. 6 shows another cuff example. Paddle cuff 100 may be used to secure two paddles simultaneously. Cuff 100 includes curved portions 104a and 104b connected via center portion 102. Center portion 102 is connected by hinge 106 to first curved portion 104a. Second curved portion 104b is connected by hinge 108 to center portion 102 also. Curved portions 104a and 104b rotate independently about hinges 106 and 108, respectively, between open and closed positions. Portions 102, 104a and 104b have extensions, each forming at least one tubular portion 110, 112 and 114, respectively. When curved portions 104a and 104b are rotated to the closed position, tubular portions 110, 112 and 114 interweave to positions that are adjacent and collinear. Collinear tubular portions 110, 112 and 114 form passage 116. When paddles are placed in open cuff 100 and portions 104a and 104b are moved to the closed positions forming passage 116, cable free end 20 may be passed through passage 116 to secure the paddles in cuff 100.

FIG. 7 shows another cuff example. Paddle cuff 200 has a locking mechanism as part of cuff 200. Cuff 200 is comprised of curved portions 262a and 262b. Cuff 200 moves from an open to a closed position by rotating curved portions 262a and 262b around hinge 264. Lock housing 266 may be provided on curved portion 262a opposite hinge 264. Lock housing 266 has closed ended passage 268 adapted to receive cable free end 20. Portion 262b has at least one extension forming tubular portion 270 opposite hinge 264. When in the closed position, tubular portion 270 and closed ended tubular portion 268 of lock housing 266 are adjacent and collinear and form one closed ended passage 272. When in the open position, a paddle shaft can be placed in cuff 200. When in the closed position, cable free end 20 may be passed into passage 272, passing through tubular portion 270. Free end 20 may be retained in passage 272 by lock housing 266 which secures the paddle in cuff 200.

Although the present disclosure has been provided with reference to the foregoing operational principles and examples, it will be apparent to those skilled in the art that various changes in form and detail may be made without departing from the spirit and scope of the disclosure. The present disclosure is intended to embrace all such alternatives, modifications and variances. Where the disclosure recites “a,” “a first,” or “another” element, or the equivalent thereof, it should be interpreted to include one or more such elements, neither requiring nor excluding two or more such elements. Furthermore, any aspect shown or described with reference to a particular example should be interpreted to be compatible with any other example, alternative, modification, or variance.

We claim:

1. A locking device for securing a recreational item having a shaft to a vehicle comprising
a first cuff having an open position and a closed position, wherein the first cuff in the closed position conformably encircles an outer surface of the shaft of the recreational item, the first cuff in the open position allowing selective placement or removal of the shaft within the first cuff, the first cuff being formed by first and second curved portions connected via a hinge device, each of the first and second curved potions having pass-through holes that line up to form a single passage when the cuff is in the closed position,
a cable having first and second end portions, the cable being configured to thread through the passage to prevent opening of the cuff, and
a lock device configured to secure the first and second end portions of the cable to prevent unthreading of the cable from the passage.

2. The device of claim 1, wherein the first end portion of the cable has a loop.

3. The device of claim 1, wherein the lock device includes a lock housing, the lock housing having a hole for receiving the cable and a retention recess for receiving the second end portion of the cable, the housing being slidable along the cable, the lock housing containing a keyed mechanism for selectively locking the second end portion of the cable in the retention recess.

4. The device of claim 1, wherein a second cuff is provided connected to the first cuff, the second cuff having an open position and a closed position, and a third curved portion having a pass-through hole that lines up with the passage when the second cuff is in the closed position.

5. The device of claim 1, further comprising
a second cuff having the same configuration as the first cuff for securing a second recreational item to the same cable.

6. The device of claim 1, wherein the cuff is dimensioned to conform around a shaft on a paddle.

7. The device of claim 1, wherein the cuff is dimensioned to conform around a tube on a bicycle frame.

8. The device of claim 1, wherein the hinge device includes one or more ring structures from each curved portion and a bolt member extending through the ring structures.

9. A locking device for securing a recreational item having a shaft to a vehicle comprising
a first cuff having an open position and a closed position, wherein the first cuff in the closed position conformably encircles an outer surface of the shaft of the recreational item, the first cuff in the open position allowing selective placement or removal of the shaft within the first cuff, the first cuff being formed by first and second curved portions connected via a hinge device, each of the first and second curved potions having an extension portion configured to mate with the extension portion of the other curved portion to define a single passage for receiving a cable and preventing opening of the cuff,
a cable having first and second end portions, the cable being configured to thread through the passage to prevent opening of the cuff, and
a lock device configured to secure the first and second end portions of the cable to prevent unthreading of the cable from the passage.

10. The device of claim 9, wherein each of the extension portions has a pass-through hole, the pass through holes lining up to form the passage when the cuff is in the closed position.

11. The device of claim 9, wherein a first extension portion has an aperture dimensioned to receive the other extension portion, the other extension portion having a hole for receiving the cable to prevent opening of the cuff.

12. The device of claim 9, wherein the first end portion of the cable has a loop.

13. The device of claim 9, wherein the lock device includes a lock housing, the lock housing having a hole for receiving the cable and a retention recess for receiving the second end portion of the cable, the housing being slidable along the cable, the lock housing containing a keyed mechanism for selectively locking the second end portion of the cable in the retention recess.

14. The device of claim 9, further comprising
a second cuff having the same configuration as the first cuff for securing a second recreational item to the same cable.

15. The device of claim 9, wherein the cuff is dimensioned to conform around a shaft on a paddle.

16. The device of claim 9, wherein the cuff is dimensioned to conform around a tube on a bicycle frame.

17. The device of claim 9, wherein the hinge device includes one or more ring structures from each curved portion and a bolt member extending through the ring structures.
